(19) United States
(12) Patent Application Publication
(10) Pub. No.: US 2004/0182618 A1
(43) Pub. Date: Sep. 23, 2004

(54) Vehicle remote control system

(76) Inventor: Ilya Nikolayev, Briarwood, NY (US)

Correspondence Address: ILYA NIKOLAYEV, 139-27 PERSHING CRESCENT, BRIARWOOD, NY, 11435, US

(21) Appl. No.: 10/391,501

(22) Filed: Mar. 18, 2003

(51) Int. Cl. B62D 1/24

(52) U.S. Cl. 180/167

(57) ABSTRACT

A vehicle remote control system includes a vehicle, actuator, receiver, and transmitter. A vehicle is outfitted with several components, including a receiver and at least one actuator, using which, a user equipped with a remote transmitter, can, from a distance, control the vehicle. This allows the life-threatening aspects of pushing a vehicle to the limit to be eliminated and allows a much more entertaining and dynamic show to be staged. By installing the components on several vehicles, a safe and very dynamic race can be created. When the vehicles collide with stationary objects or amongst themselves, instead of witnessing the driver sustain a potentially life-threatening injury, the crowd will be satisfied to see that, although the car is damaged, the driver is located a safe distance away.

### BACKGROUND OF THE INVENTION

1. Field of the Invention

In one aspect this invention relates to the remote control of full-size vehicles. In a further aspect this invention is a commercial application of the remote control of vehicles.

2. Prior Art

One of the most popular sports in the United States, and in the rest of the world as well, is automobile racing. Every year, hundreds of thousands of spectators gather at huge arenas to witness drivers taking their cars to the limit during a series of laps. As anyone who has watched automobile racing either live or on television, knows, the most entertaining and heart-wrenching moments occur either when someone is being passed or, at an even extremer emotional spectrum, when a crash occurs. It can be argued that crashes are necessary for the survival of the sport because most spectators do not gather at such an event to witness cars moving in monotonous circles but gather to see something dynamic, violent, and unique. However, history is a testament to the fact that almost every crash has its victim who is either hurt or killed. Up to now, no one has been able to offer an invention that would reconcile the need to witness a dynamic, violent, and unique event with the need to keep the driver safe. A similar problem also exists in the racing of boats, hydroplanes, go-karts, etc. This invention has been able to solve the previously mentioned problem and has thus created a commercial application for itself.

### BRIEF SUMMARY OF THE INVENTION

The system of the present invention has at least one actuator and receiver mounted on a vehicle, which is being controlled by a user equipped with a remote transmitter. The remote transmitter sends a command to the receiver using radio, infrared, or laser waves. The receiver relays the command to the actuator or actuating system, which, in turn, is able to physically control the cars movement, in a forward, backward, leftward, or rightward direction.

When several of the above-mentioned systems are combined, resulting in the creation of at least two remotely controllable vehicles, a race, or any other entertaining competition, can be created. Notwithstanding whether one vehicle or a plurality of vehicles are used, this invention allows a vehicle's maneuverability, performance, or reaction to a collision to be demonstrated to spectators in a manner that is both entertaining and safe to the driver. The user can, for example, drive the vehicle straight into a wall simply to see what will happen. Or the user can drive his vehicle into another user's vehicle simply to see what will happen. The possibilities become endless because the human element is largely eliminated. There is no longer the fear that a small mistake will lead to a catastrophe because the vehicle, and all vehicles in the vicinity are empty. Of course, there are numerous additions that can be made to the system to make it more effective. One such example is a camera can be added to the vehicle. The user's transmitter then becomes a module equipped with a display from which the user can see exactly the same thing as if he was sitting in the car.

It is understood that this invention encompasses not only automobiles, motorcycles and other road-going vehicles but also boats, jet-skis, and other vehicles using which a show may be staged.

That which is claimed is:

1. A vehicle remote control system comprising:
a vehicle which includes but is not limited to an automobile, motorcycle, all-terrain-vehicle, or go-kart;
a remote transmitter for being used by a user;
a receiver positioned at the vehicle for receiving signals from the transmitter and relaying these signals to an actuator or actuating system;
at least one actuator positioned at the vehicle's controls which functions to fulfill the user's commands.

2. A vehicle remote control system according to claim 1 wherein said system is used to stage a show, which includes, but is not limited to, a presentation of a vehicle's maneuvering capabilities, a vehicle's performance capabilities, or a vehicle's reaction to at least one collision.

3. A vehicle remote control system according to claim 2 wherein said show is a presentation of a vehicle's reaction to at least one collision, which includes, but is not limited to a collision with an object placed in its path or any other stationary or moving object.

4. A vehicle remote control system according to claim 2 wherein said show is a race with any other vehicle or moving object or a race against time.

5. A vehicle remote control system according to claim 4 wherein said show is the said race but includes at least one collision with any stationary or moving object.

6. A vehicle remote control system according to claim 1 wherein said vehicle is a full-size vehicle.

7. A vehicle remote control system according to claim 1 wherein said system is used in combination with at least one other such identical system.

8. A vehicle remote control system according to claim 7, wherein the said combination of systems is used to stage a show, which includes, but is not limited to, a presentation of a plurality of vehicles' performance capabilities, a plurality of vehicles' maneuvering capabilities, or a plurality of vehicles' reactions to at least one collision.

9. A vehicle remote control system according to claim 8 wherein said show is a presentation of a group of vehicles' reactions to at least one collision which includes, but is not limited to, a collision with a stationary object or a collision between one vehicle and at least one other vehicle.

10. A vehicle remote control system according to claim 8 wherein said show is a race between one vehicle and at least one other vehicle or is a race between each vehicle against time.

11. A vehicle remote control system according to claim 10 wherein said show is the said race but includes at least one collision.

12. A vehicle remote control system according to claim 7 wherein said vehicles are full-size.

13. A vehicle remote control system according to claim 1 wherein said system includes a camera mounted on the vehicle and at least one display which is wirelessly connected to the said camera and the said display is visible to the user controlling the vehicle.

14. A vehicle remote control system according to claim 7 wherein said system includes a plurality of cameras respectfully mounted on the vehicles and at least one display which is wirelessly connected to the said cameras and the said display is visible to the users controlling the vehicles.

15. A vehicle remote control system according to claim 1 wherein said remote transmitter can include, but is not limited to, a handheld transmitter, or a module which includes a means through which the vehicle can be turned or accelerated or decelerated.

16. A vehicle remote control system according to claim 1 wherein said actuator causes the vehicle to move in a forward, backward, leftward, or rightward motion.

17. A vehicle remote control system according to claim 1 wherein said remote transmitter can communicate with the said receiver through numerous mediums, including radio, infrared, or laser signals.

18. A vehicle remote control system according to claim 1 wherein said vehicles can also include any moving objects using which a show can be staged including boats, jet-ski's, etc.
